(19) United States
(12) Patent Application Publication
(10) Pub. No.: US 2026/0280365 A1
(43) Pub. Date: Sep. 17, 2026

(54) Stator Core

(71) Applicant: Astemo, Ltd., Chiyoda-ku, Tokyo (JP)

(72) Inventors: Mohdbasir ZULAIKA, Hitachinaka-shi, Ibaraki (JP); Kenichi NAKAYAMA, Hitachinaka-shi, Ibaraki (JP); Zhi JING, Hitachinaka-shi, Ibaraki (JP); Yuki KUMADA, Hitachinaka-shi, Ibaraki (JP)

(21) Appl. No.: 19/469,650

(22) PCT Filed: Jun. 23, 2023
(86) PCT No.: PCT/JP2023/023398

§ 371 Date: Sep. 26, 2025

(51) Int. Cl. H02K 1/20; H02K 1/16

(52) U.S. Cl. CPC H02K 1/20; H02K 1/165

(57) ABSTRACT

A stator core for use in a rotating electrical machine, comprising a core body having hollow cylindrical shape, and a cooling passage that has an opening on a first face and a second face, which are both end faces of the core body in an axial direction, and connects the both end faces and through which cooling oil passes, wherein a surface lipophilic region, which is a lipophilic region in contact with the opening, is formed around the opening on the first face, and an oleophobic region is formed on an outer side of the surface lipophilic region when viewed from the opening.

### TECHNICAL FIELD

The present invention relates to a stator core.

### BACKGROUND ART

A rotating electrical machine generates heat during operation. Heat generation tends to increase as the output of a rotating electrical machine is greater, and cooling using a cooling medium such as oil is being widely performed. PTL 1 discloses a rotating electrical machine comprising a stator having a stator core and a stator coil, a rotor that rotates relative to the stator, a coolant supply port that supplies a cooling medium to a coil end protruding from the stator core, and a guiding member that is provided along at least a part of the coil end, and used for causing the cooling medium supplied by the coolant supply port to flow along the coil end.

### CITATION LIST

### Patent Literature

[PTL 1] Japanese Unexamined Patent Application Publication No. 2011-035992

### SUMMARY OF THE INVENTION

### Problems to be Solved by the Invention

With the invention described in PTL 1, there is room for improving the cooling configuration.

### Means to Solve the Problems

The stator core according to a first mode of the present invention is for use in a rotating electrical machine, comprising a core body having hollow cylindrical shape, and a cooling passage that has an opening on a first face and a second face, which are both end faces of the core body in an axial direction, and connects the both end faces and through which cooling oil passes, wherein a surface lipophilic region, which is a lipophilic region in contact with the opening, is formed around the opening on the first face, and an oleophobic region is formed on an outer side of the surface lipophilic region when viewed from the opening.

The stator core according to a second mode of the present invention is for use in a rotating electrical machine, comprising a hollow cylindrical core body, and a plurality of cooling passages that have an opening on a first face and a second face, which are both end faces of the core body in an axial direction, and connects the both end faces and through which cooling oil passes, wherein a plurality of slots into which coils are inserted is formed on the core body, and an oleophobic region is formed on a straight line connecting the opening and the nearest slot in at least one of the openings on the first face.

### Advantageous Effects of the Invention

According to the present invention, the cooling oil can cool a wide area of the stator core.

### BRIEF DESCRIPTION OF DRAWINGS

FIG. 1 is a cross section of the rotating electrical machine.

FIG. 2 is a front view of the stator core.

FIG. 3 is a diagram showing the surface treatment of the core body in the embodiment.

FIG. 4 is a diagram explaining the effects of the embodiment.

FIG. 5 is a cross-sectional perspective view of the stator core in modified example 1.

FIG. 6 is a diagram showing the surface treatment of the core body in modified example 2.

FIG. 7 is a diagram showing the core body in modified example 3.

FIG. 8 is an enlarged view of the outer peripheral groove in modified example 3.

FIG. 9 is a diagram showing the surface treatment of the core body in modified example 5.

### DESCRIPTION OF EMBODIMENTS

### Embodiments

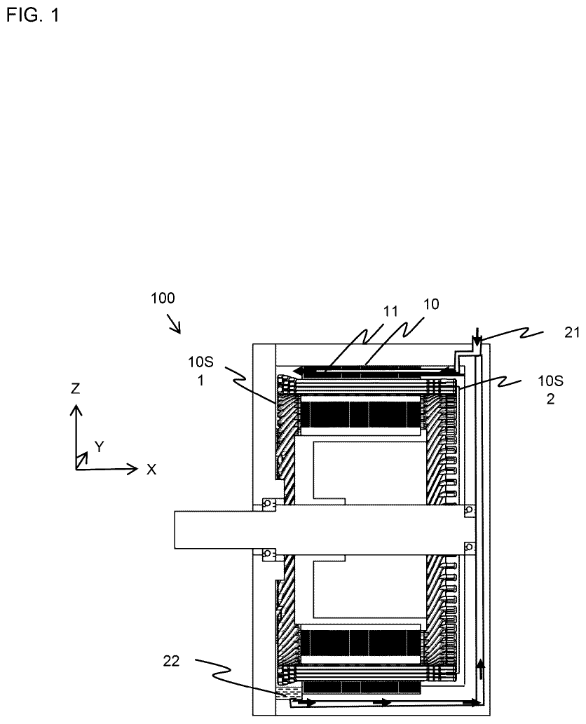

An embodiment of the stator core according to the present invention is now explained with reference to FIG. 1 to FIG. 4.

FIG. 1 is a cross section of a rotating electrical machine 100. Each diagram of the embodiment depicts mutually perpendicular XYZ axes side by side. The rotating electrical machine 100 comprises a stator core 10 that generates heat during operation. The stator core 10 has a circular ring shape, and the axis of this ring is parallel to the X axis. The stator core 10 has a first face 10S1 and a second face 10S2, which are both end faces in an axial direction. The stator core 10 comprises a cooling passage 11 that is parallel to the axial direction. The cooling passage 11 penetrates from the first face 10S1 to the second face 10S2, and cooling oil for cooling the stator core 10 flows therein. The cooling oil is supplied, for example, from an oil supply port 21 shown at the upper right part of FIG. 1, and reaches the first face 10S1 via the cooling passage 11. The negative side of the Z axis is the direction of gravity, and the cooling oil flows from the Z axis positive side to the Z axis negative side; that is, from the upper part of FIG. 1 toward the lower part of FIG. 1. The cooling oil flowing from the upper part due to gravity is collected in an oil reservoir 22 shown at the bottom part of FIG. 1, then moved back to the Z axis positive side with a pump (not shown) or the like, and once again cools the stator core 10.

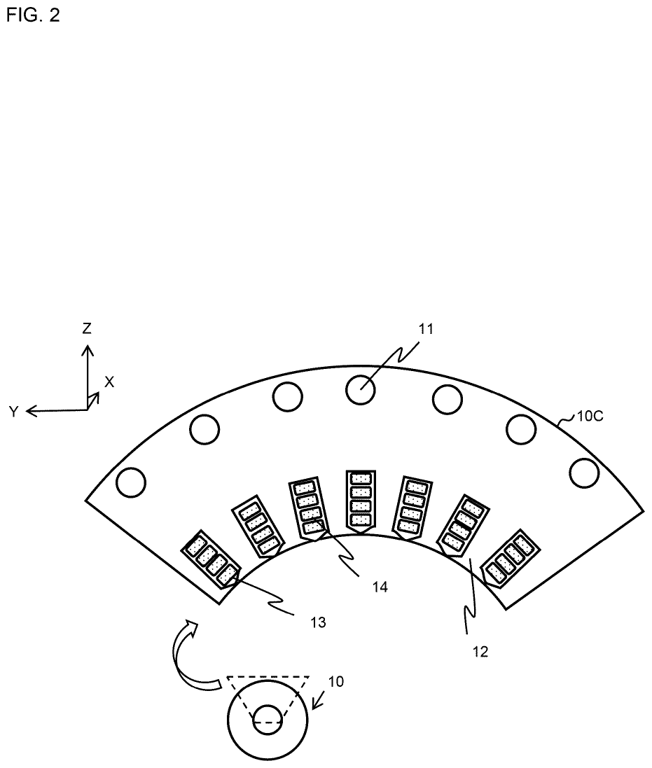

FIG. 2 is a front view of the stator core 10. FIG. 2 shows the front view of the stator core 10 as viewed from the X axis negative side in FIG. 1; that is, FIG. 2 shows the first face 10S1. As shown at the lower part of FIG. 2, the front view of the stator core 10 takes on a substantially circular ring shape. In FIG. 2, the area enclosed by the dashed trapezoid is enlarged and shown. A core body 10C configuring the stator core 10 is provided with cooling passages 11 arranged at equal intervals on its outer periphery, and provided with teeth 12 and slots 13 arranged on its inner periphery. Coils 14 are arranged in each slot 13. The cooling passages 11 penetrate to the X axis positive side; that is, the cooling passages 11 penetrate to the second face 10S, which is the other end face of the core body 10C located at the far side of FIG. 2. In the following explanation, the intersecting point of the cooling passage 11 and the first face 10S1 or the second face 10S2 is also referred to as an opening 11P. In FIG. 2, there is an equal number of openings 11P, teeth 12, and slots 13. The slots 13 are located on a straight line connecting the center of the ring of the core body 10C and the openings 11P.

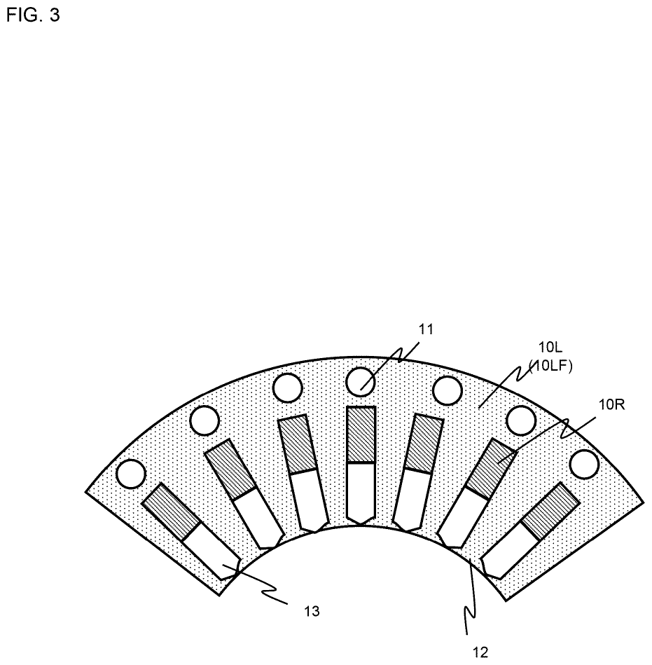

FIG. 3 is a diagram showing the surface treatment of the core body 10C. The surface of the core body 10C is divided into a lipophilic region 10L, which easily absorbs the cooling oil, and an oleophobic region 10R, which repels the cooling oil. Nevertheless, a part of the surface of the core body 10C may also be an area that is neither a lipophilic region 10L nor an oleophobic region 10R; for example, it may be an untreated region 10N that has not undergone any special treatment. The cooling oil easily penetrates the lipophilic region 10L, but cannot easily penetrate the oleophobic region 10R. In FIG. 3, the lipophilic region 10L is shown with dotted hatching, and the oleophobic region 10R is shown with diagonal hatching. Nevertheless, the coils 14 are not shown in FIG. 3 for the convenience of preparing the drawing.

The lipophilic region 10L and the oleophobic region 10R are formed by applying a known coating material. The lipophilic region 10L is arranged around the openings 11P, and the oleophobic region 10R is formed on the outer side of the lipophilic region 10L as viewed from the openings 11P. It could also be said that the oleophobic region 10R is arranged between the openings 11P and the slots 13. Note that, in the following explanation, the lipophilic region 10L formed on the first face 10S1 shown in FIG. 3 is also referred to as the “surface lipophilic region 10LF.”

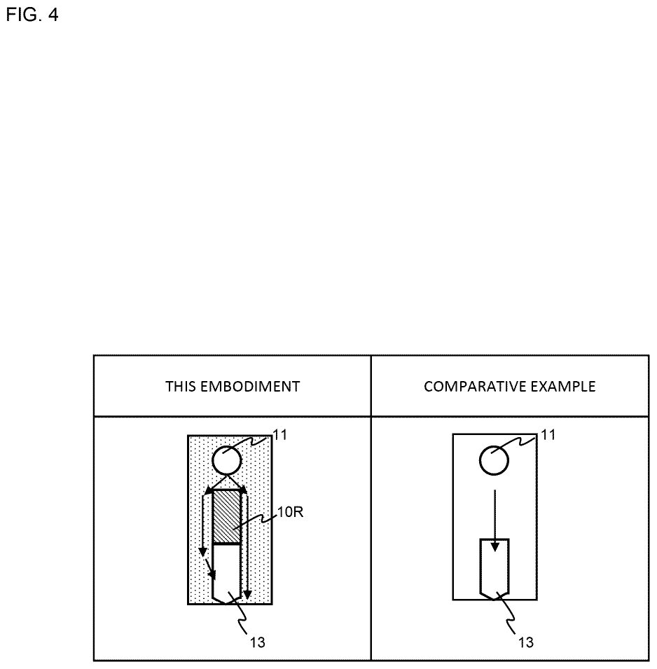

FIG. 4 is a diagram explaining the effects of the embodiment. In the embodiment, the cooling oil flowing from the openings 11P moves through the lipophilic region 10L and then flows into the slots 13 or the inner diameter side. Therefore, in the embodiment, the cooling oil can cool a wide area of the stator core 10. Meanwhile, with the comparative example in which the lipophilic region 10L and the oleophobic region 10R are not formed on the surface of the core body 10C, the cooling oil may flow down in a straight line from the opening 11P to the slot 13, resulting in the insufficient cooling of the surface of the core body 10C by the cooling oil.

According to the embodiment described above, the following effects can be obtained.
(1) A stator core 10 is for use in a rotating electrical machine 100, and comprises a hollow cylindrical core body 10C, and a cooling passage 11 that has an opening 11P on a first face 10S1 and a second face 10S2, which are both end faces of the core body 10C in an axial direction, and connects both end faces and through which cooling oil passes. A surface lipophilic region 10LF, which is a lipophilic region in contact with the opening 11P, is formed around the opening 11P on the first face 10S1. An oleophobic region 10R is formed on an outer side of the surface lipophilic region 11LF when viewed from the opening 11P. Thus, as explained with reference to FIG. 4, the cooling oil can cool a wide area of the stator core 10.
(2) A plurality of slots 13 into which coils 14 are inserted is formed on the core body 10C. The oleophobic region 10R is formed on a straight line connecting the opening 11P and the slots 13. Thus, it is possible to prevent the cooling oil from flowing in a straight line from the opening 11P to the slots 13, and increase the travel distance of the cooling oil on the first face 10S1; that is, widen the area to be cooled.

### Modified Example 1

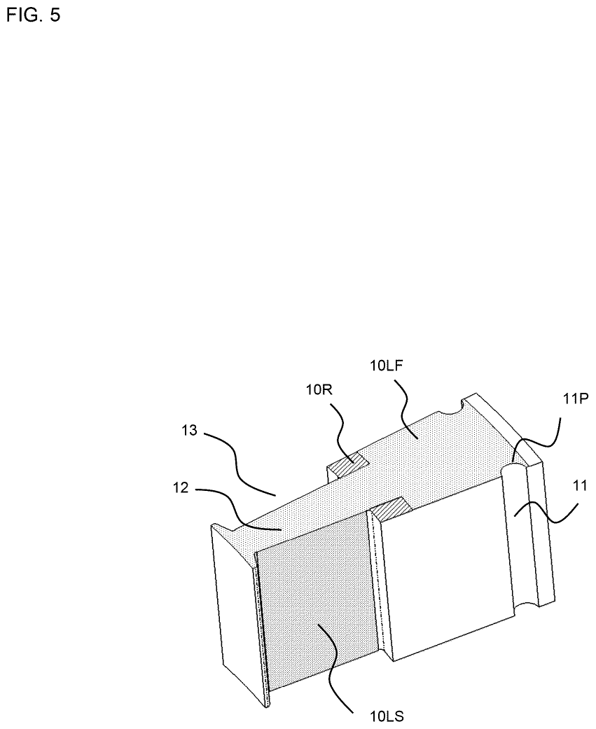

FIG. 5 is a cross-sectional perspective view of the stator core 10 in modified example 1. Nevertheless, in FIG. 5, only a part of the stator core 10 is cut out and shown. The slot 13 is an area sandwiched between the teeth 12, and in FIG. 5 the slot 13 is located on the front side and far side of the teeth 12. The upper part shown in FIG. 5 is the first face 10S1, and the arrangement of the openings 11P, the oleophobic region 10R, and the surface lipophilic region 11LF is the same as the embodiment. In this modified example, a lateral lipophilic region 10LS, which is an insulating lipophilic region, is formed on the lateral face of the teeth 12 that is substantially perpendicular to the first face 10S1.

According to this modified example 1, the following effects can be obtained in addition to the effects of the embodiment described above.
(3) The slots 13, and a plurality of teeth 12 separating the slots 13, are provided to the core body 10C. A lateral lipophilic region 10LS, which is an insulating lipophilic region, is formed on a lateral face of the teeth 12 that is substantially perpendicular to the first face 10S1. Thus, insulating paper is not required between the coils 14 and the teeth 12.

### Modified Example 2

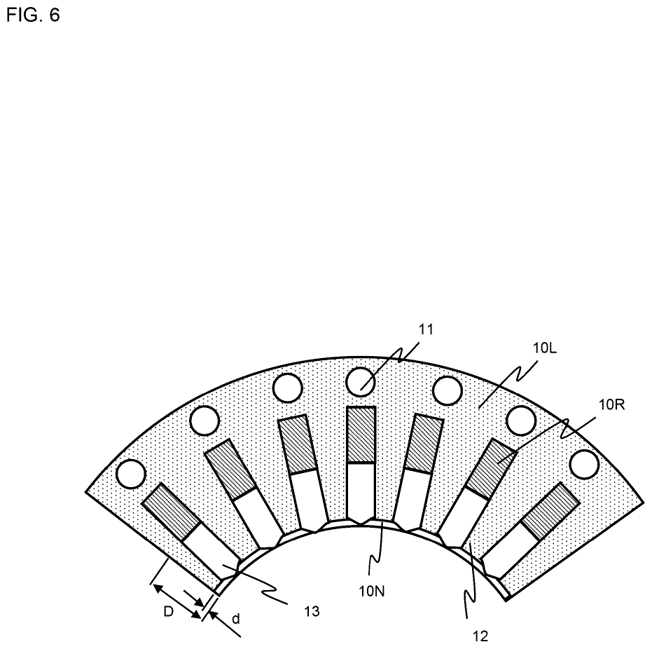

FIG. 6 is a diagram showing the surface treatment of the core body 10C in modified example 2. In the embodiment, the entirety of the teeth 12 on the first face 10S1 configured the surface lipophilic region 11LF. Nevertheless, the innermost circumference may also be an untreated region 10N that did not undergo any specific treatment. In other words, the surface of the teeth 12, excluding the innermost circumference, may configure the surface lipophilic region 11LF. There is no particular limitation regarding the length d of the untreated region 10N, and it may, for example, exceed the length D of the slots 13.

According to this modified example 2, the following effects can be obtained in addition to the effects of the embodiment described above.
(4) A lipophilic region is formed on a surface of the teeth 12, excluding an innermost circumference, on the first face 10S1. Thus, the cooling oil is more likely to flow to the slots 13 rather than to the inner circumferential side of the core body 10C, and tends to come into contact with the coils 14 disposed in the slots 13 and remove their heat.

### Modified Example 3

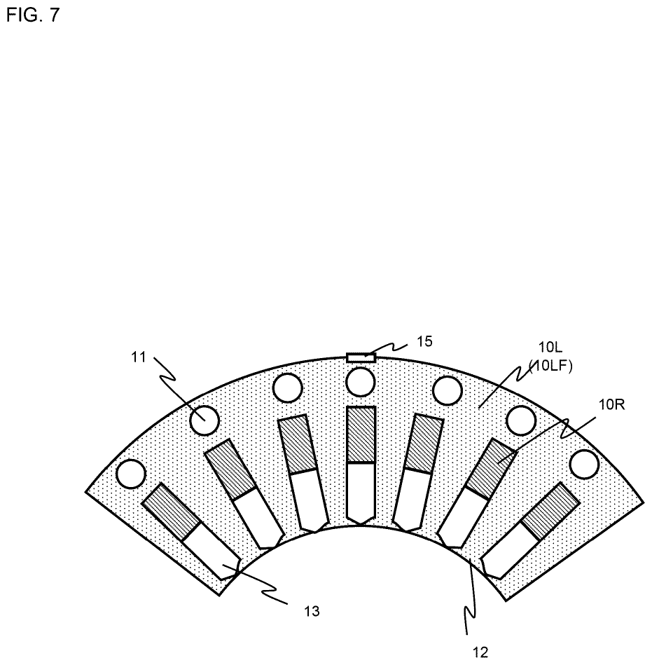

FIG. 7 is a diagram showing the core body 10C in modified example 3. The difference in comparison to the embodiment is that an outer peripheral groove 15 extending in an axial direction is provided to the outer periphery. Only one outer peripheral groove 15 may be provided, or two outer peripheral grooves 15 may be provided at a phase of 180 degrees, or three or more outer peripheral grooves 15 may be provided.

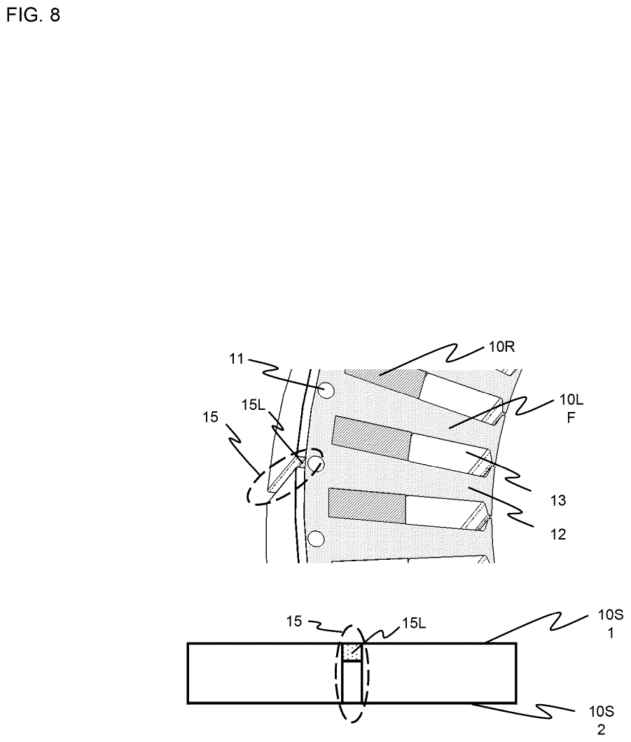

FIG. 8 is an enlarged view of the outer peripheral groove 15. Specifically, the upper part of FIG. 8 shows a perspective view of the outer peripheral groove 15, and the lower part of FIG. 8 shows a front view of the outer peripheral groove 15. FIG. 8 shows that the outer peripheral groove 15 reaches the second face 10S2 from the first face 10S1. Moreover, a groove lipophilic region 15L, which is a lipophilic region, is formed at an end part of the first face 10S1 side of the outer peripheral groove 15.

According to this modified example 3, the following effects can be obtained in addition to the effects of the embodiment described above.
(5) The core body 10C has an outer peripheral groove 15 extending in the axial direction on its outer periphery. A groove lipophilic region 15L is formed on an end part of the first face side 10S1 of the outer peripheral groove 15. Thus, the cooling oil can be guided to the outer peripheral groove 15, while minimizing the decrease in the cooling performance. If the entirety of the outer peripheral groove 15 is to configure the lipophilic region, because the entirety of the outer peripheral groove 15 will be covered by the coating film, the area of direct contact of the cooling oil and the core body 10C will be reduced, thereby decreasing the cooling effect.
(6) The outer peripheral groove 15 is provided in a plurality, and therefore allows the cooling oil to flow easily.

### Modified Example 4

In the embodiment, it was explained that the surface lipophilic region 10LF and the oleophobic region 10R are formed on the first face 10S1. Nevertheless, the surface lipophilic region 10LF and the oleophobic region 10R may also be similarly formed on the second face 10S2, in addition to being formed on the first face 10S1. The surface lipophilic region 10LF formed on the second face 10S2 is hereinafter also referred to as the “second face surface lipophilic region.”

According to this Modified example 4, the following effects can be obtained in addition to the effects of the embodiment described above.
(7) A second face surface lipophilic region, which is a lipophilic region in contact with the opening 11P, is formed around the opening 11P on the second face. Thus, the cooling oil can cool a wide area of the stator core 10 on both faces of the core body 10C.

### Modified Example 5

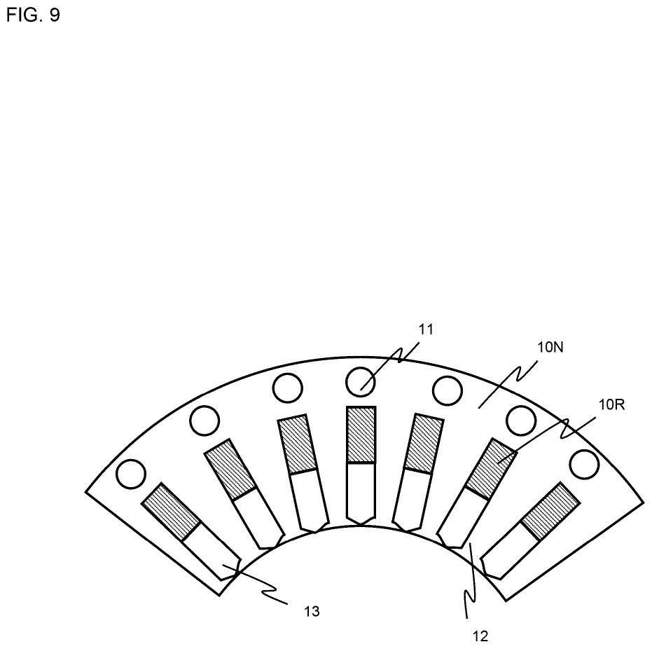

FIG. 9 is a diagram showing the surface treatment of the core body 10C in modified example 5. In the embodiment, the surface lipophilic region 10LF and the oleophobic region 10R were formed on the first face 10S1. Nevertheless, as shown in FIG. 9, the surface lipophilic region 10LF does not need to be provided on the first face 10S1. In FIG. 9, the surface lipophilic region 10LF has been changed to an untreated region 10N from FIG. 3 of the embodiment.

According to this modified example 5, the following effects can be obtained.
(8) An oleophobic region 10R is formed on a straight line with the nearest slot in at least one of the openings 11P on the first face 10S1. Thus, the cooling oil can cool a wide area of the stator core 10 even when a lipophilic region is not provided.

### Modified Example 6

In the embodiment described above, the center of the core body 10C, the slots 13, and the openings 11P were arranged in a straight line. Nevertheless, they may be out of phase with each other without being arranged in a straight line, and the number of slots 13 and the number of openings 11P may also be different.

The embodiment and modified examples described above may also be combined with each other. While various embodiments and modified examples have been explained above, the present invention is not limited to the subject matter of such embodiments and modified examples. Other modes considered to fall within the technical scope of the present invention are also included in the scope of the present invention.

### REFERENCE SIGNS LIST

10: Stator core
10C: Core body
10L: Lipophilic region
10LF: Surface lipophilic region
10LS: Lateral lipophilic region
10N: Untreated region
10R: Oleophobic region
10S1: First face
10S2: Second face
11: Cooling passage
11LF: Surface lipophilic region
11P: Opening
12: Teeth
13: Slot
14: Coil
15: Outer peripheral groove
15L: Groove lipophilic region
100: Rotating electrical machine

1. A stator core for use in a rotating electrical machine, comprising:
a core body having hollow cylindrical shape; and
a cooling passage that has an opening on a first face and a second face, which are both end faces of the core body in an axial direction, and connects the both end faces and through which cooling oil passes,
wherein:
a surface lipophilic region, which is a lipophilic region in contact with the opening, is formed around the opening on the first face; and
an oleophobic region is formed on an outer side of the surface lipophilic region when viewed from the opening.

2. The stator core according to claim 1, wherein:
a plurality of slots into which coils are inserted is formed on the core body; and the oleophobic region is formed on a straight line connecting the opening and the slots.

3. The stator core according to claim 1, wherein:
a plurality of slots into which coils are inserted, and a plurality of teeth separating the slots, are provided to the core body; and
a lateral lipophilic region, which is an insulating lipophilic region, is formed on a lateral face of the teeth that is substantially perpendicular to the first face.

4. The stator core according to claim 1, wherein:
a plurality of slots into which coils are inserted, and a plurality of teeth separating the slots, are provided to the core body; and
a lipophilic region is formed on a surface of the teeth, excluding an innermost circumference, on the first face.

5. The stator core according to claim 1, wherein:
the core body has an outer peripheral groove extending in the axial direction on its outer periphery; and
a lipophilic region is formed at an end of the first face side of the outer peripheral groove.

6. The stator core according to claim 5, wherein:
the outer peripheral groove is provided in a plurality.

7. The stator core according to claim 1, wherein:
a second face surface lipophilic region, which is a lipophilic region in contact with the opening, is formed around the opening on the second face.

8. A stator core for use in a rotating electrical machine, comprising:
a hollow cylindrical core body; and
a plurality of cooling passages that have an opening on a first face and a second face, which are both end faces of the core body in an axial direction, and connects the both end faces and through which cooling oil passes,
wherein:
a plurality of slots into which coils are inserted is formed on the core body; and an oleophobic region is formed on a straight line connecting the opening and the nearest slot in at least one of the openings on the first face.
